(19) United States
(12) Patent Application Publication
(10) Pub. No.: US 2021/0339525 A1
(43) Pub. Date: Nov. 4, 2021

(54) LIQUID DISCHARGE CONTROL DEVICE AND LIQUID DISCHARGE APPARATUS INCORPORATING SAME

(71) Applicant: Toshihiro Tsukagoshi, Kanagawa (JP)

(72) Inventor: Toshihiro Tsukagoshi, Kanagawa (JP)

(73) Assignee: Ricoh Company, Ltd., Tokyo (JP)

(21) Appl. No.: 17/223,193

(22) Filed: Apr. 6, 2021

(30) Foreign Application Priority Data
May 1, 2020 (JP) 2020-081394

(51) Int. Cl. B41J 2/045

(52) U.S. Cl. CPC B41J 2/04573; B41J 2/04581

(57) ABSTRACT

A liquid discharge control device includes an adhesion state detector and circuitry. The adhesion state detector detects an adhesion state of a droplet adhering to a medium being conveyed. The droplet is discharged from a liquid discharge device. The circuitry controls a discharge operation of the liquid discharge device based on an operation parameter, determines a difference between the adhesion state of the droplet and a reference adhesion state of the droplet on the medium being conveyed, and updates the operation parameter based on a determination result.

### CROSS-REFERENCE TO RELATED APPLICATION

This patent application is based on and claims priority pursuant to 35 U.S.C. § 119(a) to Japanese Patent Application No. 2020-081394, filed on May 1, 2020, in the Japan Patent Office, the entire disclosure of which is hereby incorporated by reference herein.

### BACKGROUND

### Technical Field

Aspects of the present disclosure relate to a liquid discharge control device and a liquid discharge apparatus incorporating the liquid discharge control device.

### Description of the Related Art

A certain liquid discharge apparatus forms a droplet with liquid ink, and discharges and attaches the droplet onto a medium. An example of the liquid discharge apparatus is an image forming apparatus that forms an image with the droplets. The liquid discharge apparatus includes a discharge head mechanism including nozzles to discharge the droplet and a liquid discharge control device to control a discharge operation of the discharge head mechanism.

The discharge head mechanism generally uses piezoelectric elements that are deformed by application of a voltage. In the discharge head mechanism, even if drive voltage waveforms applied to the piezoelectric elements are the same at the same time, variations occur in the discharge speed and the volume of the droplet of the liquid ink from each nozzle due to manufacturing tolerances such as physical structures of individual liquid chambers for supplying the liquid ink to individual nozzles and characteristics of the piezoelectric elements. Therefore, variations in the position and the volume of the droplet may cause the image quality to deteriorate when the image is formed with the droplets.

### SUMMARY

Embodiments of the present disclosure describe an improved liquid discharge control device that includes an adhesion state detector and circuitry. The adhesion state detector detects an adhesion state of a droplet adhering to a medium being conveyed. The droplet is discharged from a liquid discharge device. The circuitry controls a discharge operation of the liquid discharge device based on an operation parameter, determines a difference between the adhesion state of the droplet and a reference adhesion state of the droplet on the medium being conveyed, and updates the operation parameter based on a determination result.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view illustrating an overall configuration of an inkjet printer as an embodiment of a liquid discharge apparatus according to the present disclosure;

FIG. 2 is a block diagram illustrating an overall configuration of a droplet measurement device as an embodiment of a liquid discharge control device according to the present disclosure;

FIG. 3 is a block diagram illustrating a configuration of a discharge controller included in the droplet measurement device;

FIGS. 4A and 4B are schematic views illustrating a configuration of a liquid discharge head included in the droplet measurement device;

FIG. 5 is a graph illustrating examples of characteristics of liquid ink applicable in an embodiment of the present disclosure;

FIG. 6 is a timing chart illustrating an example of a droplet measurement operation by the droplet measurement device;

FIG. 7 is a schematic diagram illustrating an example of an adhesion state of droplets measured in the droplet measurement operation;

FIG. 8 is a schematic diagram illustrating an example of a deviation in the size of the droplets measured in the droplet measurement operation;

FIG. 9 is a graph illustrating the relation between operation parameters and a drive voltage waveform used in the droplet measurement operation;

FIG. 10 is a timing chart illustrating another example of the droplet measurement operation by the droplet measurement device; and

FIG. 11 is a schematic diagram illustrating another example of the adhesion state of the droplets measured in the droplet measurement operation.

The accompanying drawings are intended to depict embodiments of the present disclosure and should not be interpreted to limit the scope thereof. The accompanying drawings are not to be considered as drawn to scale unless explicitly noted. In addition, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

As used herein, the singular forms “a”, “an”, and “the” are intended to include the plural forms as well, unless the context clearly indicates otherwise.

Hereinafter, embodiments of a liquid discharge control device and a liquid discharge apparatus according to the present disclosure are described with reference to the drawings. In the present embodiment, an inkjet printer 1 as an embodiment of the liquid discharge apparatus includes a droplet measurement device 10 as an embodiment of the liquid discharge control device.

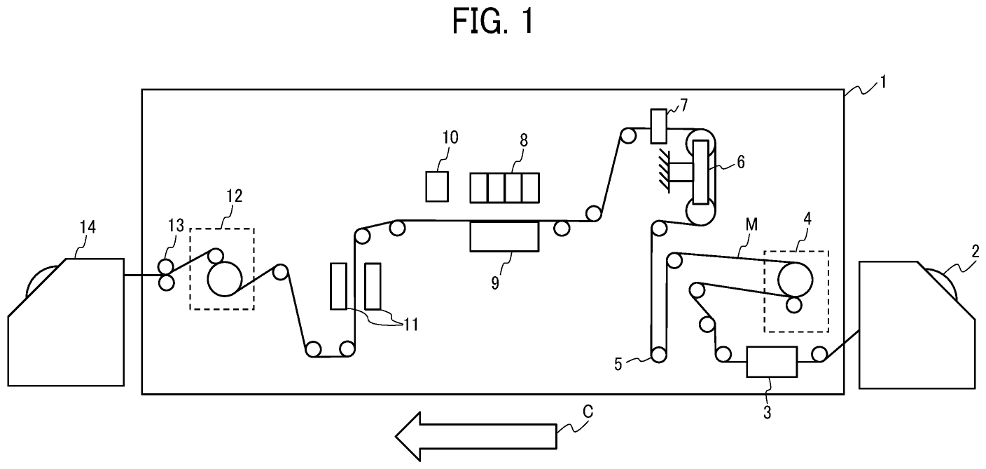

The inkjet printer 1 discharges a droplet onto a medium M. A medium supply device 2 and a medium collection device 14 convey the medium M in the inkjet printer 1 in the direction (i.e., conveyance direction) indicated by arrow C in FIG. 1. As illustrated in FIG. 1, the medium M is a continuous sheet. In the present embodiment, the inkjet printer 1 is a line scanning type in on-demand system, for example. The medium supply device 2 feeds the medium M to the inkjet printer 1 at high speed. The inkjet printer 1 forms a desired color image on the medium M. Then, the medium collection device 14 winds and collects the medium M.

The inkjet printer 1 includes a medium conveyance device to convey the medium M therein. The medium conveyance device includes a restriction guide 3, an infeed unit 4, a dancer roller 5, an edge position control (EPC) 6, a meandering amount detector 7, an outfeed unit 12, and a puller 13. The restriction guide 3 positions the medium M fed from the medium supply device 2 in the width direction of the medium M. The infeed unit 4 includes a driven roller and a drive roller. The dancer roller 5 moves up and down in response to tension of the medium M and outputs signals of the position thereof. The EPC controls the meandering of the medium M. The meandering amount detector 7 is used for feedback of a meandering amount of the medium M. The outfeed unit 12 includes a driven roller and a drive roller that rotate at a constant speed to convey the medium M at a set speed. The puller 13 includes a drive roller and a driven roller that eject the medium M outside the inkjet printer 1. The medium conveyance device included in the inkjet printer 1 is a tension control type that detects the position of the dancer roller 5 and controls the rotation of the infeed unit 4 to keep the tension of the medium M constant while conveying the medium M.

The inkjet printer 1 further includes a discharge head array 8 in which a plurality of liquid discharge heads 80 is arranged, a platen 9 disposed facing the discharge head array 8, and a drying device 11 therein. The discharge head array 8 as a liquid discharge device is a line-shaped inkjet head in which the liquid discharge heads 80 described later are arranged over the entire width of an image formation area of the medium M. The discharge head array 8 discharges liquid ink of each color of black, cyan, magenta, and yellow to form a color image. The face of the nozzle plate of the discharge head array 8 is supported so as to keep a gap above the platen 9. A discharge controller 110 described later causes the discharge head array 8 to perform a discharge operation synchronized with the conveyance speed of the medium M, thereby forming the color image on the medium M. The structure of the liquid discharge head 80 is described later.

The drying device 11 dries and fixes ink droplets adhering the medium M, which are discharged from the discharge head array 8, to prevent the ink droplets from adhering to other portions. In the inkjet printer 1 according to the present embodiment, the drying device 11 is a non-contact type in which the medium M does not contact the heating mechanism of the drying device 11, but a contact type drying device in which the medium M contacts the heating mechanism can be used.

The droplet measurement device 10 is disposed downstream from the discharge head array 8 in the conveyance direction of the medium M. The droplet measurement device 10 can acquire an adhesion state of ink droplets on the medium M immediately after the discharge operation (image forming operation) to the medium M without stopping the operation of the inkjet printer 1. That is, the inkjet printer 1 can update (correct) an operation parameter of the discharge operation of the droplet based on the state (adhesion state) of the droplets adhering to the medium M while continuing the discharge operation (image forming operation). Accordingly, the inkjet printer 1 can perform feedback control on the image forming operation (discharge operation) by using information (data) based on the adhesion state of the droplets on the medium M being conveyed at high speed.

In the inkjet printer 1, the droplet measurement device 10 may be disposed between the discharge head array 8 and the drying device 11 or may be disposed downstream from the drying device 11. Preferably, the droplet measurement device 10 is disposed close to the discharge head array 8 because the number of digits (amount of calculation) for calculating a landing position (adhesion position) of the droplet and the time can be reduced. Accordingly, the scale of the control circuit can be reduced.

The droplet measurement device 10 captures an image of the surface of the medium M to which a droplet adheres (hereinafter referred to as a “droplet adhesion surface”) at a predetermined timing and calculates update information based on the image data. The update information is used for updating the operation parameter to control the discharge operation of the plurality of liquid discharge heads 80 included in the discharge head array 8. Here, the update information includes extraction of characteristic quantity of the droplet on the medium M and correction (update) data of the operation parameter based on the characteristic quantity. Then, based on the correction data, the droplet measurement device 10 calculates data for correcting the shape and drive timing of a drive voltage waveform applied to operate the liquid discharge head 80, and transmits the data to the discharge controller 110 (described later), thereby implementing the feedback control.

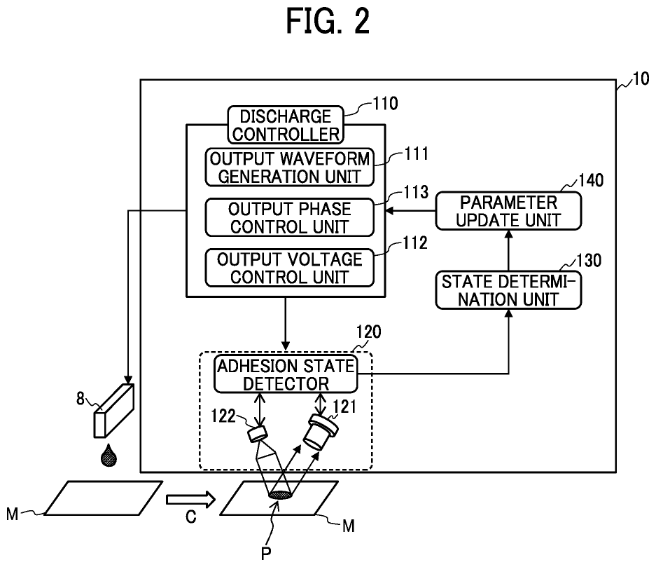

Next, the configuration of the droplet measurement device 10 is described with reference to FIG. 2. The droplet measurement device 10 includes at least the discharge controller 110, an adhesion state detector 120, a state determination unit 130, and a parameter update unit 140. The discharge controller 110 controls the discharge operation of each of the plurality of liquid discharge heads 80 included in the discharge head array 8. The adhesion state detector 120 detects the adhesion state of the droplet that is discharged and adheres to the medium M.

The adhesion state detector 120 includes a mechanism that detects the state (adhesion state) of the droplet, which is discharged onto the medium M being conveyed and adheres to the medium M, while the medium M is being conveyed. The adhesion state detector 120 includes at least a camera 121 as an imaging device, a pulsed light source 122 as a flash irradiation device, and an imaging control unit that controls the operations thereof. The medium conveyance device conveys the medium M at a designated conveyance speed in the inkjet printer 1. The discharge controller 110 causes the discharge head array 8 to discharge a droplet to the medium M based on a control timing to control the discharge operation of the droplet. Accordingly, the time at which the droplet on the medium M passes through the imaging area of the camera 121 is determined based on a discharge timing to discharge the droplet and the conveyance speed of the medium M. Therefore, at the time when a predetermined time has elapsed after the discharge timing, the adhesion state detector 120 causes the pulsed light source 122 to perform a flash irradiation operation of irradiating the medium M with a flash having a required amount of light in a certain time width. Then, the camera 121 performs an imaging operation of capturing an image of the medium M based on the timing of the flash irradiation operation of the pulsed light source 122.

The camera 121 includes an imaging element formed of a complementary metal oxide semiconductor (CMOS) element or a charge-coupled device (CCD) element. The pulsed light source 122 irradiates a predetermined position of the medium M with the flash, and the camera 121 receives the reflected light from the predetermined position, thereby capturing an image of a droplet P that lands at the predetermined position of the medium M. The pulsed light source 122 is a light source element that emits light with the required amount of light for capturing a dot image, and may be a laser diode (LD), for example. A pulsed light (flash) emitted from the pulsed light source 122 has a time width of about 15 to 20 nanoseconds. Therefore, the camera 121 captures an image of the droplet adhesion surface in accordance with the irradiation time of the pulsed light, and the adhesion state detector 120 can detect the adhesion state of the droplet P landed on the medium M (hereinafter, simply referred to as a “landed droplet P”) as the image. The landed droplet P that forms a dot image has a diameter on the order of micrometer. The image captured by the adhesion state detector 120 is transmitted to the state determination unit 130.

Note that the type and the time width of irradiation of the pulsed light source 122 are not limited if an integrated amount of light corresponding to the light receiving sensitivity of the imaging element included in the camera 121 can be secured in the time width of several tens of nanoseconds or less. When the amount of light from a single light source is insufficient, a plurality of pulsed light sources may be provided so as to simultaneously emit light. Alternatively, the amount of light may be increased by increasing the drive voltage or drive current of the pulsed light source, or an LD array in which the light sources are arrayed or a vertical cavity surface emitting laser (VCSEL) may be used as the pulse light source. In addition, the structure of the pulsed light source 122 is not limited if the required integrated amount of light can be secured by appropriately combining the light source elements described above.

The state determination unit 130 calculates the adhesion position (coordinates) and the size (droplet size) of the landed droplet P included in the image on the droplet adhesion surface of the medium M. Here, the adhesion state includes the adhesion position and the size of the landed droplet P. Various methods can be used to calculate the adhesion position (coordinates) of the landed droplet P. For example, the image transmitted from the adhesion state detector 120 is divided into image blocks, and the state determination unit 130 calculates a position of the center of gravity of each landed droplet P based on the amount of the portion of the landed droplet P included in each image block. Then, the state determination unit 130 calculates the difference (deviation) between the position of the center of gravity (actual adhesion position) of the landed droplet P and a reference adhesion position (ideal position) of the landed droplet P. The state determination unit 130 determines the direction and amount of deviation of the landed droplet P based on the calculated deviation and transmits the determination result to the parameter update unit 140. That is, the state determination unit 130 as circuitry determines a difference between the adhesion state (position) of the landed droplet P and the reference adhesion state (position) of the landed droplet P on the medium M being conveyed.

Based on the determination result transmitted from the state determination unit 130, the parameter update unit 140 determines whether the landed droplet P deviates from the reference adhesion position (ideal position), and calculates a correction amount of the operation parameter of the discharge controller 110 so that the “direction of deviation” and the “amount of deviation” are reduced and the landed droplet P is positioned close to the reference adhesion position. Then, the parameter update unit 140 as circuitry updates the operation parameter related to a timing of the discharge operation to collect (reduce) the difference based on the calculated correction amount, and transmits the updated operation parameter to the discharge controller 110.

The discharge controller 110 as circuitry controls the discharge operation of each of the liquid discharge heads 80 included in the discharge head array 8 based on the operation parameter. The discharge controller 110 includes at least an output waveform generation unit 111, an output voltage control unit 112, and an output phase control unit 113. The output waveform generation unit 111 generates and applies the drive voltage waveform for causing the liquid discharge head 80 to perform the discharge operation. A parameter defining the magnitude of the drive voltage waveform generated by the output waveform generation unit 111 corresponds to the operation parameter. The output voltage control unit 112 includes a circuit to output the drive voltage waveform generated by the output waveform generation unit 111. The output phase control unit 113 outputs a phase signal for controlling the phase of the drive voltage waveform. The output timing and the cycle of the drive voltage waveform are set by the phase signal output from the output phase control unit 113. Therefore, the parameters for setting the output timing and the cycle also correspond to the operation parameters.

The inkjet printer 1 performs a continuous operation for a long time. During the continuous operation, the temperature inside the apparatus increases due to heat generated by required power consumption of electric circuits, and heat generated by heating and fixing processes for drying ink droplets adhering to the medium M. On the other hand, the temperature inside the apparatus may decrease due to the effect of a mechanism for dissipating the generated heat to the outside or a mechanism for intentionally cooling the entire area or a part of the apparatus. In particular, in the large-sized inkjet printer 1, during the continuous operation for a long time, the temperature inside the apparatus repeatedly increases and decreases by more than ±5 degrees.

The liquid ink discharged from the discharge head array 8 changes in viscosity depending on a variation in temperature environment. In addition, the characteristics of the configuration for the discharge operation of the discharge head array 8 may change depending on the variation in temperature environment. The discharge characteristics of the discharge head array 8 may change depending on various factors due to the variation in temperature environment during the continuous operation for a long time. As a result, the position and size of the droplet adhering to the medium M may change. The droplet has a diameter on the order of micrometer. Therefore, in the present embodiment, the operation parameter of the discharge head array 8 is updated by the feedback control during the operation of the inkjet printer 1 based on the position and size of the landed droplet P that is actually discharged and adheres to the medium M. Thus, the accuracy of the discharge operation can be maintained and improved. The characteristics of the liquid ink is described later.

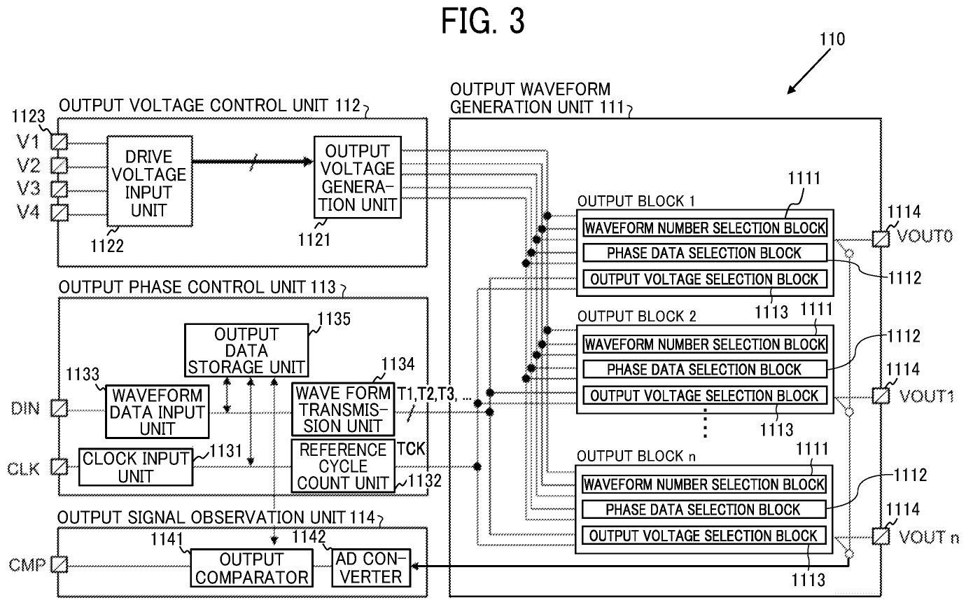

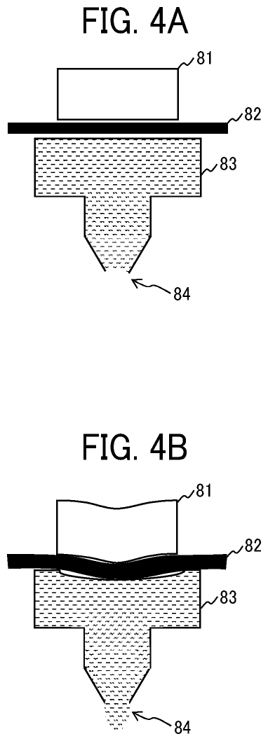

A description is given below of the configuration of the discharge controller 110 in further detail. FIG. 3 is a block diagram illustrating a configuration of a driver integrated circuit (IC) as hardware constructing the discharge controller 110. The driver IC applies a predetermined drive voltage waveform to a piezoelectric element 81 (see FIGS. 4A and 4B) to control the discharge timing at which a droplet is discharged from each nozzle 84 and the volume of the discharged droplet. As illustrated in FIG. 3, the discharge controller 110 includes the output waveform generation unit 111, the output voltage control unit 112, the output phase control unit 113, and an output signal observation unit 114.

The output waveform generation unit 111 includes output blocks and output terminals 1114 corresponding to the output blocks, respectively. Each output block includes a waveform number selection block 1111, a phase data selection block 1112, and an output voltage selection block 1113. The output waveform generation unit 111 supplies multiple voltages in a designated order to the piezoelectric element 81 corresponding to each of the nozzles 84 from which the droplet (ink droplet) is discharged. The output waveform generation unit 111 outputs a voltage from each output terminal 1114 (e.g., VOUT0, VOUT1, and VOUTn). The voltage is sequentially selected from a plurality of voltages received from the output voltage control unit 112 based on selection data of the waveform number, the phase, and the output voltage for each output block. The selection data is received from the output phase control unit 113.

Note that the waveform number is a number defined corresponding to each of a plurality of types of drive voltage waveforms changed in accordance with the size and volume of droplet to be discharged or environmental changes. The waveform number is set to determine whether to output the drive voltage waveform to each of the output terminals 1114. Further, each output block has only the waveform number, and the output waveform generation unit 111 generates the drive voltage waveform by referring to common data from an output data storage unit 1135 of the output phase control unit 113. Examples of the common data includes information having a large amount of data such as a change time and a voltage level of the drive voltage waveform.

The output voltage control unit 112 includes a drive voltage input unit 1122 and an output voltage generation unit 1121. Two or more fixed voltages are input to the drive voltage input unit 1122. The output voltage generation unit 1121 generates a plurality of voltages to be supplied to the output waveform generation unit 111. The output voltage control unit 112 supplies the plurality of voltages, which is required to generate an output waveform, to the output waveform generation unit 111. Depending on the operation state of the discharge controller 110 (driver IC), the output voltage generation unit 1121 outputs voltages input from input terminals 1123 (e.g., V1, V2, V3, and V4) at the same potentials or generates and outputs new voltages based on the voltages input from the input terminals 1123. Further, when the output voltage control unit 112 receives variable voltages from the input terminal 1123 as usual, the output voltage control unit 112 outputs the variable voltages.

The output phase control unit 113 controls a designated voltage and time to be output as the drive voltage waveform for each output. The output phase control unit 113 includes a clock input unit 1131, a reference cycle count unit 1132, a waveform data input unit 1133, a waveform transmission unit 1134, and the output data storage unit 1135. The clock input unit 1131 inputs a clock as a reference for the operation of the driver IC. The reference cycle count unit 1132 counts the reference clock and causes the internal state of the driver IC to transition at a required timing. The waveform data input unit 1133 receives a plurality of drive voltage waveform data based on image control data to properly discharge ink droplets from designated nozzles 84. The waveform transmission unit 1134 selects the drive voltage waveform for each drive voltage waveform data input to the waveform data input unit 1133 and each nozzle 84, and transmits a waveform for switching the output voltage according to the timing of the discharge operation determined for each nozzle 84. The output data storage unit 1135 stores several types of drive voltage waveforms, and time and voltage data to discharge a droplet for each nozzle 84.

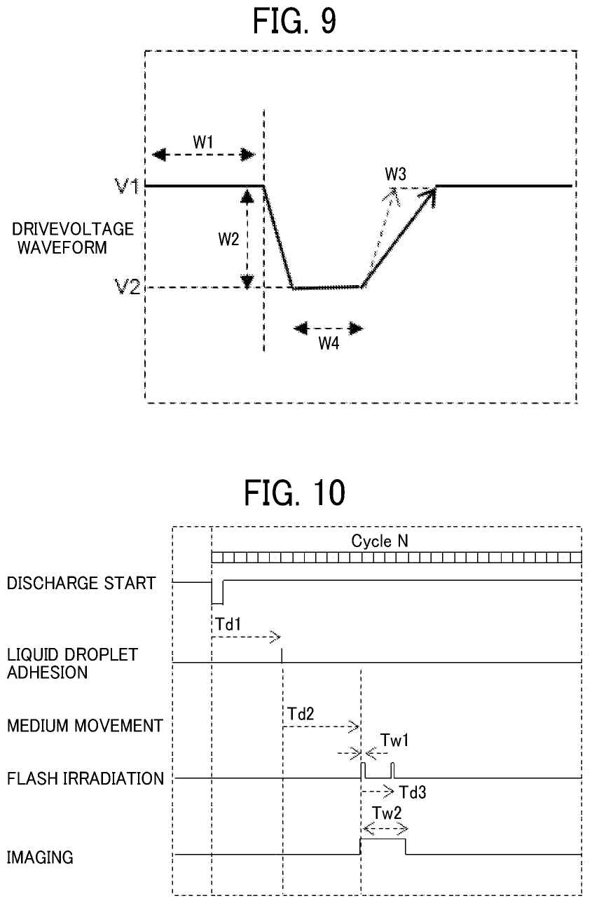

In the discharge controller 110 according to the present embodiment, the reference cycle count unit 1132 counts the reference clock in multiple cycles, thereby forming an ink discharge cycle. As illustrated in FIG. 9 described later, the output data storage unit 1135 stores the plurality of drive voltage waveform data that is common to the discharge operation for discharging droplets by all the nozzles 84 to use the storage capacity of the output data storage unit 1135 efficiently.

The output signal observation unit 114 selects the drive voltage waveform applied to each nozzle 84 and measures the voltage state of the drive voltage waveform. The output signal observation unit 114 includes an output comparator 1141 and an analog-to-digital (AD) converter 1142. The output signal observation unit 114 selects an electric signal from the output terminals 1114 (e.g., VOUT1, VOUT2, or VOUTn), receives the electric signal as an input, and converts the electric signal into a digital value by the AD converter 1142. Then, the output comparator 1141 compares the digital value with an expected value to determine the reliability of the output drive voltage waveform. The output comparator 1141 outputs the determination result as a determination signal CMP. Alternatively, the digital value converted by the AD converter 1142 may be read from the outside of the driver IC, or the electric signal that has passed through an amplifier may be directly output as an analog signal.

FIGS. 4A and 4B illustrate the configuration of liquid discharge head 80 of the discharge head array 8. As illustrated in FIGS. 4A and 4B, the liquid discharge head 80 is a general inkjet head using the piezoelectric element 81. The piezoelectric element 81 is made of a material that is deformed (contracted or expanded) by application of a voltage. The shape of the piezoelectric element 81 is physically changed in response to the level of the voltage applied to both ends of the piezoelectric element 81. A vibration plate 82 propagates the change in shape of the piezoelectric element 81 to an ink chamber 83. The ink chamber 83 supplies ink to be discharged from an ink tank via an ink tube and feeds the ink to the nozzle 84. The vibration plate 82 applies physical pressure to the ink. The nozzle 84 forms a discharge port from which the ink with a predetermined volume of droplet is discharged at a designated speed.

A positive electrode and a negative electrode are disposed at an upper end and a lower end of the piezoelectric element 81, respectively. A voltage equal to or higher than a certain value is applied between the positive electrode and the negative electrode, thereby changing the shape of the piezoelectric element 81. FIG. 4A illustrates a steady state in which no voltage is applied to the piezoelectric element 81. The ink surface is located inside the nozzle 84 and remains stable. FIG. 4B illustrates a transient state at the moment when the ink is discharged from the nozzle 84. In the transient state, as a voltage having the drive voltage waveform with a designated voltage level is applied to the piezoelectric element 81, the shape of the piezoelectric element 81 is changed by the drive voltage waveform, and the pressure is propagated to the ink chamber 83 via the vibration plate 82. As a result, a certain volume of ink is discharged from the nozzle 84. Thus, after the state illustrated in FIG. 4B, a predetermined volume of ink droplet is discharged from the nozzle 84 at a predetermined timing.

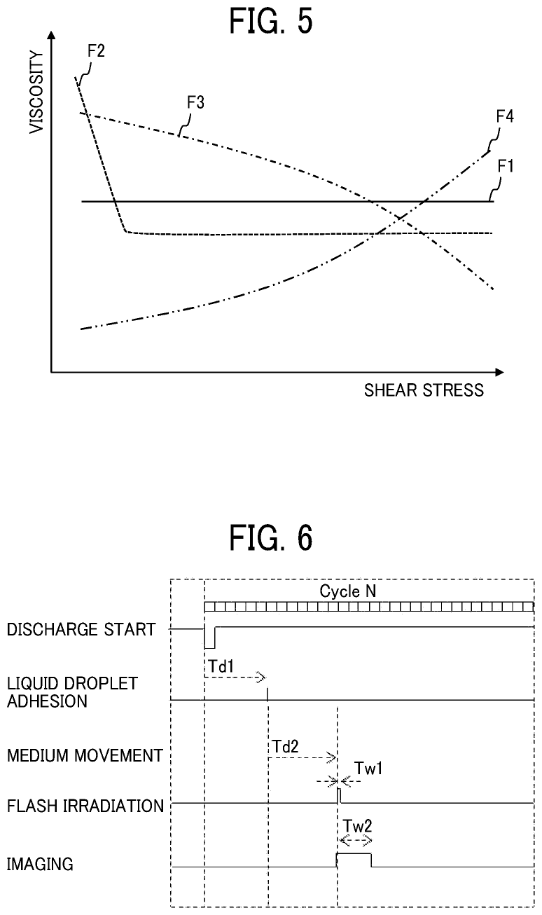

Next, the characteristics of the liquid ink used in the inkjet printer 1 are described with reference to a graph illustrated in FIG. 5. FIG. 5 is a graph in which the horizontal axis represents shear stress and the vertical axis represents viscosity. Line F1 indicates characteristics of ink corresponding to a Newtonian fluid, line F2 indicates characteristics of ink corresponding to a Bingham fluid, line F3 indicates characteristics of ink corresponding to a pseudoplastic fluid, and line F4 indicates characteristics of ink corresponding to a dilatant fluid. In general, the viscosity of liquid ink decreases as the temperature increases and increases as the temperature decreases.

In the discharge operation of discharging the liquid ink by the piezoelectric element 81, the temperature of the liquid discharge head 80 increases, and the temperature of the entire apparatus (temperature inside the apparatus) also increases. That is, since the temperature environment of the liquid ink changes due to the discharge operation, the viscosity of the liquid ink also changes. Therefore, the discharge state (timing, speed, size, and the like) of the droplet changes even when the same drive voltage waveform is applied. As a result, the landing position (adhesion position) and the size of the droplet may change, thereby affecting the quality of the image formed on the medium M.

In the present embodiment, the inkjet printer 1 does not estimate variations in the viscosity of the ink and the shear stress based on temperature change. The inkjet printer 1 directly acquires data such as the landing position (adhesion position) and the size of the droplet, which are the result of the discharge operation, and corrects the drive voltage waveform used for the discharge operation based on the acquired data. Thus, the state of the landed droplets P can remain stable over time.

Next, an example of the droplet measurement operation of the droplet measurement device 10 is described with reference to a timing chart illustrated in FIG. 6. As illustrated in FIG. 6, the discharge operation is performed based on a predetermined operation cycle. The timing chart of “discharge start” indicates the timing at which the piezoelectric element 81 is deformed by supplying the drive voltage waveform to the piezoelectric element 81, and an ink droplet is discharged from the nozzle 84.

The ink droplet lands on the medium M when a delay time Td1 has elapsed after the discharge operation of the ink droplet is performed. Since the medium M is conveyed by the medium conveyance device, the pulsed light source 122 emits light at the time when a conveyance time Td2 has elapsed after the ink droplet has landed. Simultaneously with the emission of light from the pulsed light source 122, the camera 121 captures an image of the landed droplet P.

The pulsed light source 122 emits light in a short time width. The required amount of light for capturing an image is supplied during the irradiation time Tw1 by the flash emitted from the pulsed light source 122. The imaging element of the camera 121 receives the reflected light from the medium M within a predetermined time width Tw2 corresponding to a predetermined time from the flash emitted by the pulsed light source 122, that is, after the irradiation of the flash.

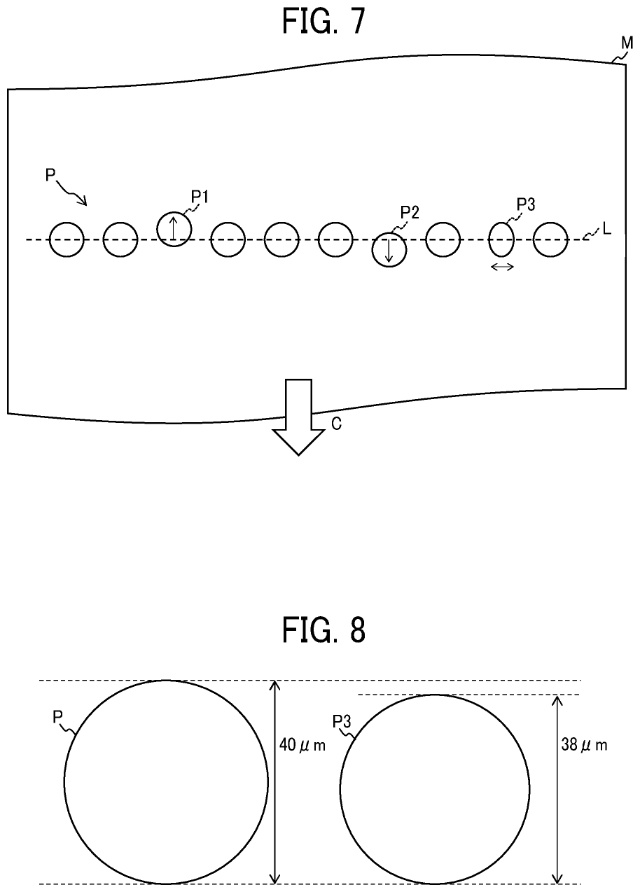

Next, a description is given of the adhesion state of the landed droplet P with reference to FIG. 7. As illustrated in FIG. 7, the landed droplets P are aligned in the direction perpendicular to the conveyance direction of the medium M. Note that FIG. 7 illustrates a state in which the landed droplets P are arranged in line for convenience of explanation, but it is not limited that the landed droplets P are arranged in a straight line in the actual discharge operation. In FIG. 7, a reference line L indicating the reference adhesion position is a virtual line and exemplifies an ideal position at which the landed droplets P adhere in the delay time Td1 when an ideal discharge operation is performed.

When the inkjet printer 1 performs the continuous operation, the discharge operation is also continuously performed. The influence of the original mechanical tolerances may cause deviations in the adhesion position and the volume of the landed droplet P due to the change in the discharge characteristics of the liquid discharge head 80 by the heat generated during the discharge operation, the change in the viscosity of the liquid ink, or the like, even if the same drive voltage waveform is applied at the same timing.

For example, a landed droplet P1 illustrated in FIG. 7 is an example in which the adhesion position is deviated from the ideal position (reference adhesion position) to the upstream side in the conveyance direction of the medium M indicated by arrow C in FIG. 7. This deviation indicates that the timing of the discharge operation of the nozzle 84 corresponding to the landed droplet P1 is later as compared with the ideal (reference) adhesion state in which a landed droplet P lands at the reference adhesion position. A landed droplet P2 is an example in which the adhesion position is deviated to the downstream side in the conveyance direction. This deviation indicates that the timing of the discharge operation of the nozzle 84 corresponding to the landed droplet P2 is faster as compared with the ideal (reference) adhesion state in which a landed droplet P lands at the reference adhesion position.

A landed droplet P3 is an example in which the volume of ink discharged from the nozzle 84 is small and the dot area of the landed droplet P3 is small. The landed droplet P spreads radially around the landing coordinate on the medium M. This spreading property is referred to as “wet spreadability”. When ink has a low viscosity, the wet spreadability of the landed droplet P is high. Accordingly, the landed droplet P becomes a large landed droplet having a long diameter or long peripheral length. When ink has a high viscosity, the wet spreadability of the landed droplet P is low. Accordingly, the landed droplet P becomes a small landed droplet having a short diameter or short peripheral length.

When the speed immediately before a droplet lands on the medium M is high, the landed droplet P becomes large, and when the speed immediately before landing is low, the landed droplet P becomes small. Further, when the volume of the droplet discharged from the nozzle 84 of the liquid discharge head 80 (inkjet head) and flying toward the medium M is large, the landed droplet P becomes large, and when the volume is small, the landed droplet P becomes small. As illustrated in FIG. 8, when the target diameter of the landed droplet P is 40 μm, if the diameter of the landed droplet P3 is reduced by 5% (2 μm), the dot area of the landed droplet P3 is reduced by about 10%. When the dot area is reduced by 10%, the color density of the image formed of the landed droplet P3 is reduced by 10% on the medium M. Therefore, the acquisition (measurement) of data of the landed droplets P in real time during the discharge operation of the droplet greatly affects the image quality of the inkjet printer 1 that changes from moment to moment. That is, in the present embodiment, the inkjet printer 1 acquires the data of the landed droplet P, determines the adhesion state of the landed droplet P in real time, and update the operation parameter of the liquid discharge head 80 based on the determination result, thereby improving the image quality of the inkjet printer 1.

The description is given with reference back to FIG. 7. Each of the landed droplets P corresponds to each of the nozzles 84 included in each of the liquid discharge heads 80 of the discharge head array 8. Accordingly, the landed droplets P can be positioned at the ideal position (reference adhesion position) by correction based on the result of the discharge operation of each of the nozzles 84 (each of the liquid discharge heads 80). Therefore, the state determination unit 130 can process the image illustrated in FIG. 7 acquired by the camera 121 and determine the direction of deviation and the amount of deviation of the landed droplet P (e.g., the landed droplets P1 and P2). Further, the state determination unit 130 can calculate the dot area of the landed droplet P3 and determine the deviation of the volume of the discharged droplet from the desired volume of the droplet.

Next, the operation parameter to be updated by the parameter update unit 140 is described. FIG. 9 illustrates an example pattern of the drive voltage waveform applied to the liquid discharge head 80 by the discharge controller 110. The drive voltage waveform includes a rectangular wave having a typical shape and four operation parameters including parameters W1 to W4.

The parameter W1 indicates the time at which the drive voltage waveform starts. When the parameter W1 is set small, the drive voltage waveform starts early to advance the timing of the discharge operation, and the droplet from the corresponding nozzle 84 lands on the medium M early. Thus, the parameter W1 is useful for positioning the landed droplet P1 illustrated FIG. 7 at the ideal position. When the parameter W1 is set large, the drive voltage waveform starts late to delay the timing of the discharge operation, and the droplet from the corresponding nozzle 84 lands on the medium M late. Thus, the parameter W1 is useful for positioning the landed droplet P2 illustrated FIG. 7 at the ideal position.

The parameter W2 indicates the peak value of the drive voltage waveform, and the parameter W3 indicates the slew rate which means the slope of the drive voltage waveform. When the parameter W2 is set large, that is, the peak value is high, or when the parameter W3 is set so as to make the slew rate steep, the discharge speed of the ink droplet is increased. The parameters W2 and W3 are useful for advancing the landing time of the ink droplet on the medium M. The parameters W2 and W3 are also useful for increasing the dot area of the ink droplet due to the wet spreadability after landing.

The parameter W4 corresponds to the pulse width of the drive voltage waveform. The volume of the ink droplet, that is, the dot size of the landed droplet P can be controlled by the parameter W4 combined with the parameters W2 and W3. When the pulse width is widened by the parameter W4, the volume of liquid to be discharged increases. The discharge speed can also be controlled by the parameters W2 and W3 With combination of the parameters W1 to W4, the discharge controller 110 can increase the volume of the droplet to be discharged and cause the droplet to land at the ideal position (reference adhesion position) at the desired timing.

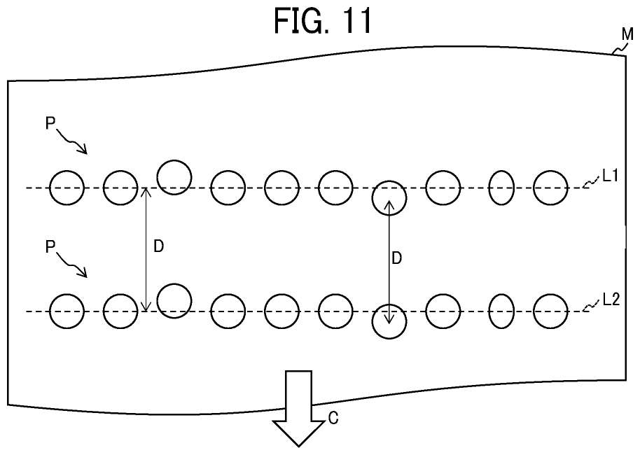

Next, another example of the operation of the droplet measurement device 10 is described with reference to a timing chart illustrated in FIG. 10. In the operation of the adhesion state detector 120 performed in conjunction with one discharge operation, the ink droplet lands on the medium M when a delay time Td1 has elapsed after the discharge operation of the ink droplet is performed. The pulsed light source 122 emits light (i.e., a first irradiation) at the time when a conveyance time Td2 has elapsed after the ink droplet has landed. Then, the pulsed light source 122 performs the next irradiation when a time Td3 has elapsed from the first irradiation. As described above, in the droplet measurement device 10 according to the present embodiment, the pulsed light source 122 emits multiple flashes within a predetermined time width Tw2 when the camera 121 captures the image of the droplet adhesion surface of the medium M. The camera 121 starts capturing an image simultaneously with the first irradiation of the pulsed light source 122. Then, the camera 121 receives the reflection light from the medium M multiple times in the predetermined time width Tw2 according to the multiple flashes of the flash irradiation operation. In the example illustrated in FIG. 10, the camera 121 captures two images of the landed droplets P in a short time at the time of the multiple flashes. That is, the camera 121 captures a plurality of images of the landed droplets P within the predetermined time from the flash (first irradiation) of the flash irradiation operation.

Next, a description is given of the adhesion state of the landed droplet P based on the timing chart illustrated in FIG. 10 with reference to FIG. 11. As illustrated in FIG. 11, the landed droplets P are arranged in the plurality of dot rows (two dot rows in the present embodiment) in the direction perpendicular to the conveyance direction of the medium M in the captured image. Note that FIG. 11 also illustrates a state in which the landed droplets P are arranged in line in each of the two dot rows for convenience of explanation, but it is not limited that the landed droplets P are arranged in a straight line in the actual discharge operation.

The pulsed light source 122 emits light twice at an interval of a certain delay time Td3. Therefore, the landed droplets P on the medium M in the captured image moves by a distance D illustrated in FIG. 11 while the delay time Td3 elapses. Based on the time width of the delay time Td3, the conveyance speed of the medium M can be calculated from the distance D between the two dot rows of the landed droplets P in the captured image. That is, while continuously operated, the inkjet printer 1 can update the operation parameter of the discharge controller 110 in accordance with the fluctuation of the conveyance speed of the medium M which is changed due to the operation of the inkjet printer 1. Therefore, the inkjet printer 1 can accurately control the liquid discharge head 80 based on the adhesion position of the landed droplet P in consideration of the fluctuation of the conveyance speed in the continuous operation for a long time, the speed fluctuation due to the weight load of the medium M, and the like.

When the amount of deviation and the deviation direction of the adhesion positions of the droplets included in each of the plurality of dot rows of the landed droplets P are within a certain range, the operation parameter can be updated based on the amounts of deviations in the plurality of dot rows, thereby improving the correction more accurately. The plurality of dot rows of the landed droplets P is separated from each other by the distance D. When the amount of deviation of the landed droplets P acquired multiple times exceeds the certain range, the inkjet printer 1 does not sufficiently correct the adhesion position of the landed droplet P by updating the operation parameter. In this case, the inkjet printer 1 may cause a notification device to issue an alarm.

Since the flash irradiation operation is performed multiple times, the conveyance speed of the medium M can be measured. Accordingly, when the amount of deviation of the landed droplets P acquired multiple times exceeds the certain range, the inkjet printer 1 can expands the certain range by adjusting the conveyance speed by the feedback control.

According to the droplet measurement device 10 described above, based on the image of the landed droplets P, the inkjet printer 1 can determine variations in the time at which the droplets land (adhere) onto the medium M in the direction perpendicular to the arrangement direction of the nozzles 84 of the liquid discharge heads 80 included in the discharge head array 8, that is, in the conveyance direction of the medium M.

That is, in the inkjet printer 1, a flash is emitted to the adhesion position of the landed droplet P on the medium M, an image of the landed droplet P is captured by the reflected light of the flash, and the deviation of the adhesion position with respect to the ideal position (reference adhesion position) is detected based on the captured image. The discharge operation of the liquid discharge head 80 is controlled for each nozzle 84. The discharge controller 110 controls the drive voltage waveform applied to the piezoelectric element 81 and the supply time thereof for each nozzle 84. Therefore, a droplet having an early landing time and a droplet having a late landing time can be distinguished in liquid discharge head 80.

Then, the number (nozzle number) of the nozzle 84 corresponding to each landed droplet P and the data of the difference in landing time are transmitted to the discharge controller 110. The discharge controller 110 supplies the drive voltage waveform to the nozzle 84 with the early landing time later and supplies the drive voltage waveform to the nozzle 84 with the late landing time earlier. With such a control, the droplet measurement device 10 can control the variation in the landing positions of the droplets to a minimum.

At the same time, the droplet measurement device 10 can measure the size (dot size or dot area) of the landed droplet P on the medium M and acquire the correlation between the size and the operation parameter. Therefore, the inkjet printer 1 can suppress the deviation from to the target dot size.

The droplet measurement device 10 measures and analyzes the position and size of the landed droplet P without stopping the operation of the inkjet printer 1. In the droplet measurement device 10, the pulsed light source 122 irradiates the medium M being conveyed with a flash with a very short time width, and the camera 121 captures an image of the droplet adhesion surface at an effective magnification. Then, based on the analysis result, the droplet measurement device 10 can perform feedback control on the image forming operation in the inkjet printer 1.

As described above, according to the present disclosure, the liquid discharge control device can detect the adhesion state of the droplet adhering to the medium being conveyed from the medium being conveyed and perform feedback control on the discharge operation.

The present disclosure is not limited to specific embodiments described above, and numerous additional modifications and variations are possible in light of the teachings within the technical scope of the appended claims. It is therefore to be understood that, the disclosure of the present specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

What is claimed is:

1. A liquid discharge control device comprising:
an adhesion state detector configured to detect an adhesion state of a droplet adhering to a medium being conveyed, the droplet discharged from a liquid discharge device; and
circuitry configured to:
control a discharge operation of the liquid discharge device based on an operation parameter;
determine a difference between the adhesion state of the droplet and a reference adhesion state of the droplet on the medium being conveyed; and
update the operation parameter based on a determination result.

2. The liquid discharge control device according to claim 1,
wherein the adhesion state includes an adhesion position, and the reference adhesion state includes a reference adhesion position,
wherein the adhesion state detector is configured to detect the adhesion position of the droplet on the medium, and
wherein the circuitry is configured to calculate a difference between the adhesion position and the reference adhesion position of the droplet and update the operation parameter to correct the difference.

3. The liquid discharge control device according to claim 2,
wherein the circuitry is configured to change the operation parameter related to a timing of the discharge operation to reduce the difference.

4. The liquid discharge control device according to claim 3,
wherein the circuitry is configured to:
update the operation parameter to advance the timing of the discharge operation when the adhesion position deviates to an upstream side in a conveyance direction of the medium with respect to the reference adhesion position; and
update the operation parameter to delay the timing of the discharge operation when the adhesion position deviates to a downstream side in the conveyance direction of the medium with respect to the reference adhesion position.

5. The liquid discharge control device according to claim 1,
wherein the adhesion state detector includes:
a flash irradiation device configured to irradiate a droplet adhesion surface of the medium being conveyed with a flash having a certain time width; and
an imaging device configured to capture an image of the droplet on the droplet adhesion surface within a predetermined time from the flash.

6. The liquid discharge control device according to claim 5,
wherein the flash irradiation device is configured to emit multiple flashes within the predetermined time,
wherein the imaging device is configured to capture a plurality of images of the droplet on the droplet adhesion surface of the medium being conveyed within the predetermined time at a time of the multiple flashes, and
wherein the circuitry is configured to determine a conveyance speed of the medium based on the plurality of images of the droplet.

7. A liquid discharge apparatus comprising:
a medium conveyance device configured to convey a medium;
a liquid discharge device configured to discharge a droplet to the medium; and
the liquid discharge control device according to claim 1.
